(19) United States
(12) Patent Application Publication
(10) Pub. No.: US 2005/0203791 A1
(43) Pub. Date: Sep. 15, 2005

(54) METHOD AND SYSTEM FOR ANTICIPATING, IDENTIFYING, ANALYZING AND MEETING CONSUMER NEEDS

(76) Inventor: Francois Nadal, St Mande (FR)

Correspondence Address: JEFFREY FURR, 253 N. MAIN STREET, JOHNSTOWN, OH, 43031, US

(21) Appl. No.: 10/908,868

(22) Filed: May 31, 2005

(30) Foreign Application Priority Data
Nov. 29, 2002 (WO) 2004/051526 A1

(51) Int. Cl. G06F 17/60

(52) U.S. Cl. 705/10; 705/1

(57) ABSTRACT

The invention relates to an automatic method and system of anticipating, identifying, analyzing and meeting the needs of consumers (1) in real time. The inventive method involves the use of computer processing means (2) and said means are supplied with personal data (3) relating to the activities of consumers. The method comprises a step in which a software component (4) is associated with the aforementioned computer processing means (2) enabling the needs of the consumers (1) to be ascertained from the personal data (3). The software component (4) employs a software module (8) which is structured into the following elements: consumer environments (9) which are adapted to the activity of the consumer (1); objects which are suited (10) to the activity of the consumer (1); and actions which are attached (11) to the suitable objects (10). The method also comprises a step in which the computer processing software component (4) is distributed to the consumers (1).

### RELATED APPLICATION

This application claims the benefit of PCT Application WO 2004/051526, with a priority date of Nov. 28, 2002.

### BACKGROUND

1. Field of the Invention

The invention relates to an automatic method and system for anticipating, identifying, analyzing and meeting the needs of consumers in real time.

2. Description of Prior Art

Methods of identifying consumer needs are known, in particular within the banking industry. The known methods and systems administered by the banks use data bases and management devices regarding client relations. These client relation data bases and management devices are set up during initial meetings between the bank's client representative and their client once a year.

Methods of analyzing consumer needs are known, in particular within the banking industry. The known methods and systems administered by the banks use data analysis devices (For example, by means of inquiries into the data base, filters, and automatic analysis of fiscal cash).

Methods of analyzing consumer needs are known, in particular within the banking industry. The known methods and systems administered by the banks use marketing devices such as electronic mailings, telephone interviews, regular mail.

Methods are known on the internet where the consumer enters personal information and where simulations and comparisons are made on banking products.

On the one part there exists management software, and on the other part, methods of analyzing consumer needs such as those defined hereunder, but there are no solutions that integrate management software that enable automatic identification of consumer needs.

Management software that is integrated and adapted to the needs of each profession are known (Textile industry, construction), however, there is none that offers a solution that is unique, enabling an automatic and/or manual adaptation of the solution to meet the needs of the user.

Management software is known. Notwithstanding, their level of adaptability is close to zero (Possibility to hide certain options that are not used), where the cost of adaptation is high and requires expert advice, but there is no solution where the adaptation of the software can be done directly by anyone lacking the necessary expertise.

Integrated management software is known, but it does not enable an ergonomic navigation within the environment of professions of users that can be personalised by and/or for them (Environment of commerce, construction, agro food industry).

Integrated management software that administer the past (Accounting) and the present (Invoicing) are known. It is also known that there exists budgeting software but no integrated solution that administers in a perfectly fluent manner the past, present and future.

There are known management software programs that administer one or more of the following actions: Estimates, invoices, payments, payment orders to a bank, downloading of bank statements, bank reconciliation, budgeting, production of financial statements, but there is no integrated solution that enables the user to affect all of these operations with a single click.

There are known explorers that are supplied primarily by operating systems that enable the consumer to visualise and/or access files and directories stored on a hard drive, but there is no solution that enables the consumer to organise access to their files and/or directories in a personalised way by presenting the manner in which they organise their activities on the screen.

### SUMMARY OF THE INVENTION

The invention relates to an automatic method and system of anticipating, identifying, analyzing and meeting the needs of consumers (1) in real time. The inventive method involves the use of computer processing means (2) and said means are supplied with personal data (3) relating to the activities of consumers. The method comprises a step in which a software component (4) is associated with the aforementioned computer processing means (2) enabling the needs of the consumers (1) to be ascertained from the personal data (3). The software component (4) employs a software module (8) which is structured into the following elements: consumer environments (9) which are adapted to the activity of the consumer (1); objects which are suited (10) to the activity of the consumer (1); and actions which are attached (11) to the suitable objects (10). The method also comprises a step in which the computer processing software component (4) is distributed to the consumers (1).

### GLOSSARY OF TERMS

Business World

| Nominal Group | Ref. No. |
|---|---|
| Consumer(s) | 1 |
| Data processing means | 2 |
| Personal data | 3 |
| Software components | 4 |
| Operators | 5 |
| Complementary data | 6 |
| Forecast statements | 7 |
| Software module | 8 |
| Consumer environment | 9 |
| Appropriate objects | 10 |
| Related actions | 11 |
| Memory | 12 |
| Descriptions | 13 |
| Object description | 13a |
| Indicators | 14 |
| Object indicators | 14a |
| Degrees of relevance | 15 |
| Screen | 16 |
| Computer device | 17 |
| First classification of need s | 18 |
| Table of classification of need s | 18a |
| Column of needs ranking | 18b |
| Column of images of need s | 18c |
| Column of comments on need s | 18d |
| Column of comments on the | 18e |
| solution To needs | |
| State of need s | 19 |
| Table of need s | 19a |
| Column of image of need | 19b |
| Column summary with comments on | 19c |
| state of need indicators | |
| Table of indicators | 19d |
| Column of icon indicators | 19e |
| Column indicator titles | 19f |
| Column of indicator values | 19g |
| Column of indicator comments | 19h |
| Second classification | 20 |
| Table of classification of | 20a |
| products and services | |
| Column ranking of products and | 20b |
| services | |
| Column of images of products | 20c |
| and services | |
| Column of values of products | 20d |
| and services | |
| Column of comment son products | 20e |
| and services | |
| Method of action | 21 |
| Table of classification of | 21a |
| possible actions | |
| Column of ranking of possible | 21b |
| actions | |
| Column of comments on possible | 21c |
| actions | |
| Column of values of possible | 21d |
| actions | |
| Buttons | 21e |
| Computer devices | 22 |
| Methods of calculation | 23 |
| First methods of calculation | 24 |
| Second method of calculation | 25 |
| Third method of calculation | 26 |
| Method of distribution | 27 |
| Methods of posting | 28 |
| Need s | 30 |
| Past statements | 31 |
| State of product and service | 40a |
| Table of product and service | 40b |
| Column of summary with comments | 40c |
| on product and service | |
| Table of advantages and | 40d |
| disadvantages of product and | |
| service | |
| Column of images illustrating | 40e |
| the advantages and disadvantages | |
| Column of title of advantage | 40f |
| and disadvantage | |
| Column of value of advantage | 40g |
| and disadvantage | |
| Column of summary with comments | 40h |
| on advantage and disadvantage | |
| Table of product and service | 40i |
| characteristics | |
| Column of image of | 40j |
| characteristics of product and | |
| service | |
| Column of title of | 40k |
| characteristics of product and | |
| service | |
| Column of values of | 40l |
| characteristics of product and | |
| service | |
| Column of summary with comments | 40m |
| on characteristics of product | |
| and service | |
| First window of general | 70 |
| navigation | |
| First navigation bar | 71 |
| Select | 71a |
| Return | 71b |
| Advance | 71c |
| In use | 71d |
| Post | 71e |
| Personalise | 71f |
| Explorer | 72 |
| First environment explorer | 72a |
| Second object explorer | 72b |
| Third action explorer | 72c |
| Creating in first | 72d |
| Deleting in first | 72e |
| Modifying in first | 72f |
| Creating in second | 72g |
| Deleting in second | 72h |
| Modifying in second | 72i |
| Creating in third | 72j |
| Deleting in third | 72k |
| Modifying in third | 72l |
| Sixth click | 72m |
| Seventh click | 72n |
| Eighth click | 72o |
| Ninth click | 72p |
| Tenth click | 72q |
| First posting | 72r |
| Second posting | 72s |
| Eleventh click | 72t |
| Second navigation window | 73 |
| Environment presentations | 74 |
| Image zones | 74a |
| Text zones | 74b |
| Action assistants | 75 |
| Stages | 75a |
| Blocks | 75b |
| Fields | 75c |
| Images | 75d |
| Text zones | 75e |
| Tables | 75f |
| Buttons | 75g |
| Second navigation bar | 76 |
| Text zones posting the title | 76a |
| Previous | 76b |
| Next | 76c |
| Adapt | 76d |
| Close | 76e |
| Environment | 77a |
| Objects | 77b |
| Actions | 77c |
| Memory zone | 80a |
| Models of use | 80b |
| History of actions | 80c |
| Fourth method of calculation | 80d |
| Usage indicators | 80e |
| Fifth method of calculation | 80f |
| Automatic modification | 80g |
| First click | 90 |
| Scroll sin first | 90a |
| Second click | 90b |
| Posts in first | 90c |
| Third click | 90d |
| Scrolls in second | 90e |
| Fourth click | 90f |
| Posts in second | 90g |
| Fifth click | 90h |
| Scrolls in third | 90i |
| Capture forecasts | 200a |
| Create estimates and/or command | 200b |
| and/or invoices | |
| Create payment schedule | 200c |
| Register payments | 200d |
| Register payment orders | 200e |
| Recover bank statements | 200f |
| Consult statements in | 200g |
| particular past and future cash | |
| flow | |
| Sixth method of calculation | 200h |
| Create in first | 200i |
| Move | 200i1 |
| Create in second | 200j |
| Create in third | 200k |
| Create in fourth | 200L |
| Create and/or modify in fifth | 200m |
| Calculate in first | 200n |
| Execute in first | 200o |
| Seventh method of calculation | 200r |
| Accounting reports | 200s |
| Eighth method of calculation | 200t |
| Series of stages | 200z |
| Unique click function | 201 |
| Unique click window | 201a |
| Unique click button | 201b |
| Table of bank statements | 201c |
| Table of solutions | 201d |
| Find another solution button | 201e |
| Consulter details of the | 201f |
| solution button | |
| First sub method of calculation | 300 |
| Second sub method of | 3001 |
| calculation | |
| Third sub method of calculation | 3002 |

### BRIEF DESCRIPTION OF THE DRAWINGS

Other characteristics and advantages of the invention will appear upon reading the Description of variations in design offered as an example (As an indication only, not exhaustive), and:

FIG. 1 that represents in a simplified manner the general operation of a variation in design of the system according to the invention.

FIGS. 2a and 2b that represent in a simplified manner a variation in design of the methods of calculation enabling the calculation of the needs of consumers 1.

FIGS. 3, 4, 5, 6, 7 that represent in a simplified manner a variation in design of the posting of a first classification of needs 18 of a consumer, and the posting of a second classification 20 of products and services of an operator responding to the needs of consumer 1.

FIG. 8 that represents in a simplified manner a variation in design of a first navigation window 70.

FIG. 9 that represents in a simplified manner a variation in design of a first level of operation of a 72 explorer.

FIG. 10 that represents in a simplified manner a variation in design of a second level of operation of explorer 72.

FIG. 11 that represents in a simplified manner a variation in design of a second window of navigation 73.

FIG. 12 that represents in a simplified manner the operation of an Environment 74 presentation.

FIG. 13 that represents in a simplified manner the operation of a 75 action assistant.

FIG. 14 that represents in a simplified manner the system's automatic adaptation method.

FIG. 15 that represents in a simplified manner one of the operations of traditional administration of software module 8.

FIG. 16 that represents in a simplified manner the operation of a unique click function (201).

FIG. 17 that represents in a simplified manner a unique window click (201a).

### DESCRIPTION OF THE PREFERRED EMBODIMENT

The invention concerns a method that enables anticipating, identifying, analysing and responding to consumer needs in real time. Within the meaning of this invention, consumer is understood to be a firm as well as an individual.

The context is the following: Consumers use data processing methods, in particular management modules and/or navigation devices. Consumers supply the data processing methods with personal data related to their activities.

According to the invention, the method includes the stage of associating a software program to the data processing software from their personal data that enables showing consumer needs. Within the meaning of this invention, consumer needs are understood to mean needs other than those for which data processing methods are used. For example, it can refer to needs in terms of financial products, banking, leasing, insurance, retirement, pension, multimedia (Telephone, computer, etc.), travel, office consumables (Ink, paper, pens), material investment (Car purchase or rental, office furniture), software programs, recreation, etc. The program uses a software module structured as follows:
A consumer environment adapted to the consumer's activity, in particular their professional and personal environment.
Objects that are appropriate to the activity of the consumer, in particular for the professional environment, the objects client, supplier, bank, employee.
Actions linked to appropriate objects; in particular for the object client, the actions create an invoice, see overdue payment clients, and create a sales forecast.

According to the invention the method also includes a stage to distribute the software data processing components to consumers.

Whilst respecting confidentiality of information provided, the technical effects of this combination of stages for users are in particular the following:
Gain consumer loyalty.
Acquire new consumers.
Reduce the sales cycle on products offered by operators to consumers.
Reduce the cost of processing by optimising the time spent by commercial services of operators and/or fixed costs generated by:
Offering personalised and quality advice to all consumers.

According to the invention, the technical effects of the combination of stages are, in the case where the operator is a financial institution, in particular the following: The method enables the financial institution to:
Increase the level of <<Cross sales>> of bank products to the consumer.
Obtain global information on the financial situation of a consumer that uses many banks.
Make the consumer aware of bank products offered.
Direct the consumer towards the most appropriate sales outlet.

Within the meaning of this invention, it is understood by <<Cross sales>>, all complementary products other than standard financial products that an institution can sell to its clients [Refer to definitions outlined under studies carried out by BCG (Boston Consulting Group) or Mc Kinsey]. For example, <<Cross sales>> bank products can include withdrawals, insurance, savings plans, and employee wages administration software.

The method also enables the financial institution to increase profitability on existing client accounts.

According to the invention, the technical effects of the combination of stages for consumers having access to software components are, in particular, that it enables them to dispose of better visibility regarding their activity.

According to the invention, the method enables consumers to:
Dispose of an integrated solution of administration, navigation, means of payment, and advice.
Dispose of a solution that enables managing the entire data of the consumer activity with a single click.
Complete integration of past, present and future financial flows enabling in particular, on the one part, to automatically generate budget reports from past accounting reports and on the other part, to generate forecasts from reports that emanate from accounting.

Within the banking industry, according to the invention, the method enables consumers to automatically transform bank statements into accounting reports.

The invention concerns in particular the case where the methods for data processing are designed to provide statements on past and/or present situations, in particular accounting statements from personal data related to the activity of the consumers. Preferably, according to the invention, the method is such that in order to highlight consumer needs, the software components:
Calculate forecasting statements from (i) personal data related to the activities of the consumers and/or (ii) complementary data provided by consumers and related to their activities.
Calculate consumer needs (i) from personal data (ii) complementary data (iii) and/or forecasting reports.

It results from the combination of these technical elements:
That the analysis of consumer needs, normally the operator's domain, is effected in a decentralised manner by the consumer using the software component.
The operators, at least in part, find themselves free from the constraint of maintaining a competent and available sales force in order to determine the needs of consumers that are susceptible of calling upon their services and/or products.
The relation between operators and consumers is automatic and strengthened, whilst the current tendency leads towards the destruction of the value chain, in particular between banks and consumers.

Preferably, according to the invention, the software module enables, also, to activate the following stages:
The stage of automatically generating statements and/or documents, in particular during the use of attached actions.
The stage of calculating the forecast automatically upon each update by the consumer and/or complementary data related to their activities.
The stage of storing in memory:
On the one part, personal data and/or complementary data and/or forecasting statements.
On the other part, product and/or service identifiers offered by the operators.

The software module also enables to automatically calculate the needs of consumers by initiating the calculation stage from data stored in memory.
The indicators regarding consumer activity.
The degrees of relevance of products and/or services offered by the operators.

It is thus possible to determine the needs of the consumer that are susceptible to be satisfied with the products and/or services of operators.

The software module also enables to activate the stage of proposing products and/or services to the consumer that correspond to the needs thus calculated.

Preferably, according to the invention, the software module also includes the stage of posting a computer device on the screen:
A first classification of consumer needs as a function of degrees of relevance, and/or
A statement of consumer needs and indicators,
A second classification and/or statement of products and services of operators responding to consumer needs, in particular by presenting the advantages and disadvantages of products and services thus classified or appearing in the statements, and/or
Action methods enabling consumers to purchase the products and services thus classified or appearing on the statement.

System

The invention also concerns a system that enables anticipating, identifying, analysing and responding to consumer needs in real time. Consumers activate a computer device that includes data processing methods, in particular management modules and/or navigation modules. The consumers provide the data processing methods with personal data related to their activities. The system includes a data processing software component associated to data processing devices. The software component enables revealing the needs of the consumer from personal data. The software component activates a software module structured as follows:
Consumer environments adapted to the consumer's activity, in particular the professional and personal environments.
The objects that are appropriate to the consumer's activity, in particular for the professional environment, the objects client, supplier, bank, and employee.
The actions related to appropriate objects; in particular for the object client, the actions create an invoice, see overdue payment clients, and create a sales forecast.

The data processing software component is distributed among consumers.

The invention relates in particular to the case where the means of data processing is designed to provide statements on past and/or present situations, in particular accounting statements, from personal data related to the activities of the consumers. Preferably, according to the invention, in this case the software component includes methods of calculation enabling to reveal consumer needs. These calculation methods enable to calculate:
Forecast statements from (i) personal data related to the activities of consumers and/or (ii) complementary data provided by consumers relative to their activities.
The needs of consumers (i) from personal data (ii) and/or complementary data (iii) and/or forecast statements.

Preferably, according to the invention, the software module includes also the first means for calculation enabling:
To automatically generate statements and/or documents, in particular during updating of these actions.
To automatically calculate forecasts upon each update by the consumer, insofar as the personal data and/or complementary data related to their activities is concerned.

The data processing software component includes also a memory enabling to store:
On the one part, personal data and/or complementary data and/or forecast statements.
On the other part, identifiers of products and/or services offered by the operators.

The software module includes also a second method of calculation in order to calculate the following items from data stored in memory:
Indicators regarding the activity of the consumer.
Degrees of relevance of products and/or services offered by the operators.

The software module also includes a third calculating method in order to calculate the needs of consumers from the indicators and their degree of relevance. The software module also includes means of distribution to offer consumers products and/or services corresponding to the needs thus calculated.

Preferably, according to the invention, the software module includes also methods to post a computer device on the screen:
A first classification of consumer needs as a function of the degrees of relevance and/or
A statement regarding consumer needs and indicators, and/or
A second classification and/or statement of products and services of operators responding to the needs of consumers, in particular by presenting the advantages and disadvantages of products and services thus classified or appearing on the statement of needs, and/or
Actions enabling consumers to purchase the products and services thus classified or appearing on the statement.

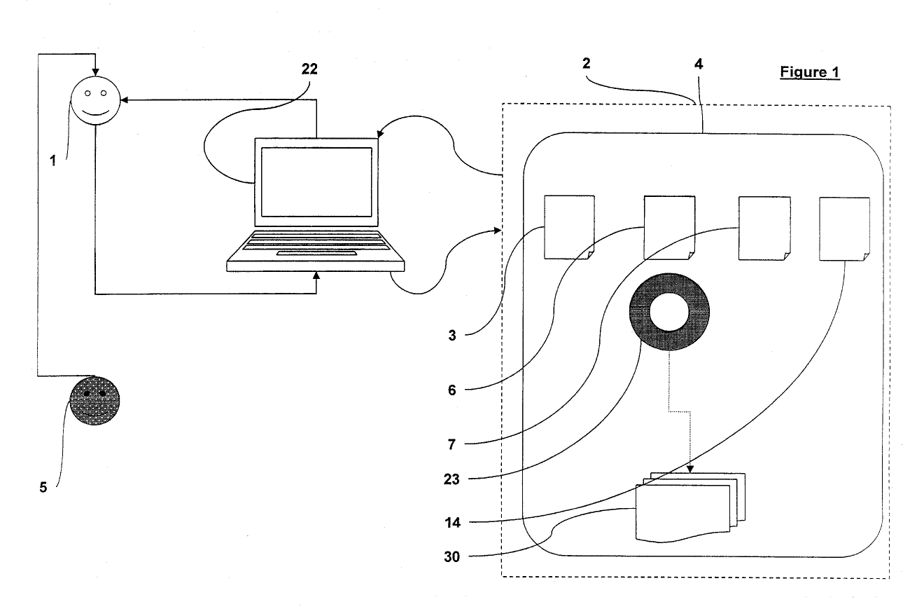

By referring to FIG. 1, a description will now be made on a variation in design in method and system according to the invention. According to the invention, the method and the system relate to an automatic method to enable anticipating, identifying, analyzing and meeting the needs of consumers 1 in real time. Consumers 1 activate computer device 22 that includes management and/or navigation modules. Consumers 1 provide data processing methods 2 with personal data 3 related to their activities.

The system includes data processing software components 4, associated to data processing software 2. These software components enable revealing the needs of consumers 1, in particular from personal data 3. The data processing software components 4 are distributed by the operator 5 to consumers 1.

The means of data processing 2 are in particular designed to provide statements on past and/or present situations, in particular the accounting statements from personal data 3 relative to the activities of consumers 1.

The software components 4 include methods of calculation 23 enabling to reveal the needs 30 of consumers 1. The means of calculation 23 calculate forecast statements 7 from (i) personal data 3 relevant to the activities of consumers 1 and/or (ii) complementary data 6 provided by consumers 1 relative to their activities. The methods of calculation 23 calculate the needs of consumers 1 from (i) personal data 3 and/or (ii) complementary data 6 (iii) and/or forecast statements 7 and/or indicators 14 on the consumer activity under consideration.

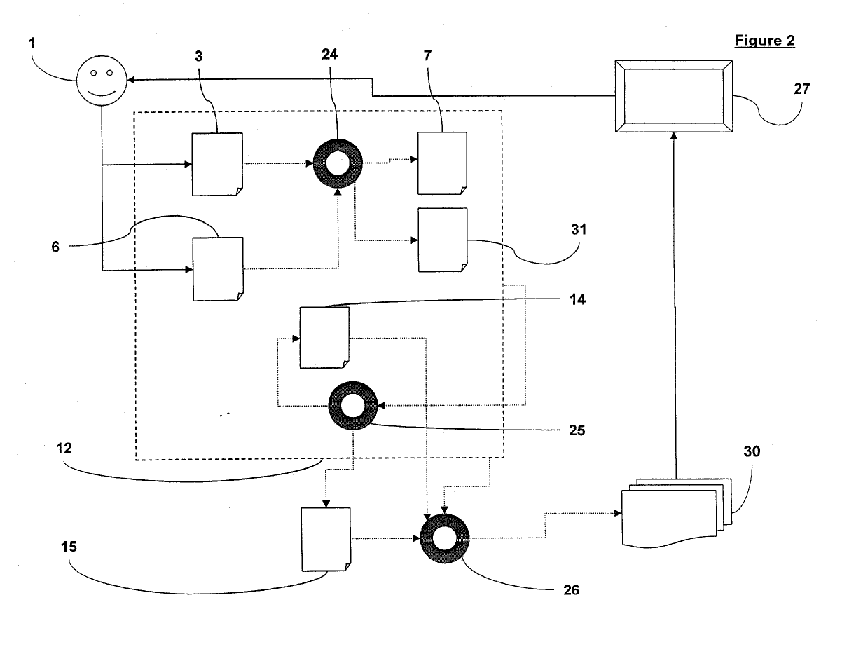

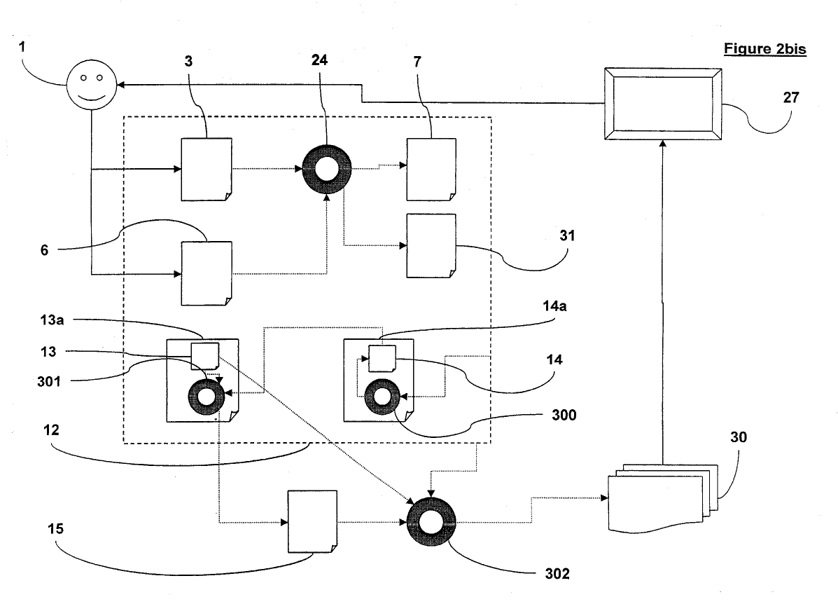

Now a description will follow by referring to FIGS. 2a and 2b, regarding software module 8, according to the invention and its functions. The software module 8 includes the first method of calculation 24. The first method of calculation 24 automatically generates statements and/or documents upon updating related actions 11. The first means of calculation 24 also automatically calculates the forecast statements 7 upon each update of personal data 3 and/or complementary data 6 relative to the activities of said consumer 1.

In order to further explain the notion of actions that are attached 11, it is specified that, according to the invention, software module 8 is structured as follows:
Consumer environment 9, adapted to the activity of the consumer, namely the professional and personal environment.
Appropriate objects 10 attached to the activity of the consumer, in particular for the professional environment, the objects client, bank, supplier, employee.
Actions 111 that are attached in particular to the object client: create an invoice, see overdue payment clients, and create a sales forecast.

Data processing software component 4 includes also a memory 12 enabling the storage of:
On the one part, personal data 3 and/or complementary data 6 and/or forecast statements 7.
On the other part, description 13 of products and/or services offered by operator 5.

Software module 8 includes also a second method of calculation 25 in order to effect calculations from data stored in memory 12:
Indicators 14 of consumer activity.
Degrees of relevance 15, in relation to indicators 14, products and/or services offered by operator 5.

Software module 8 includes also a third method of calculation 26 in order to calculate the needs of consumer 1 from indicators 14 and degrees of relevance 15.

The software module 8 includes also distribution methods 27 to offer consumers 1 products and/or services corresponding to the needs thus calculated.

Now by referring to FIG. 2a, there will follow a description of a variation in design of calculation methods 24 by specifying the additional devices of calculation enabling to calculate the needs of consumer 1.

Software module 8 includes also the first calculation method 300 integrated into the second method of calculation 25 included in each object indicator 14a, the indicators 14 from data stored in memory 12.

Software module 8 includes also a second method of calculation 301 integrated to the second calculation method 25, included in each descriptive object 13a, in order to calculate degrees of relevance 15 in relation to indicators 14 and/or in relation to descriptions 13 of products and/or services offered by operator 5.

Software module 8 include also a third calculation device 302 integrated into a third calculation device 26 for the needs 30 of consumers 1, from degrees of relevance 15 and descriptions 13 and other data stored in memory 12.

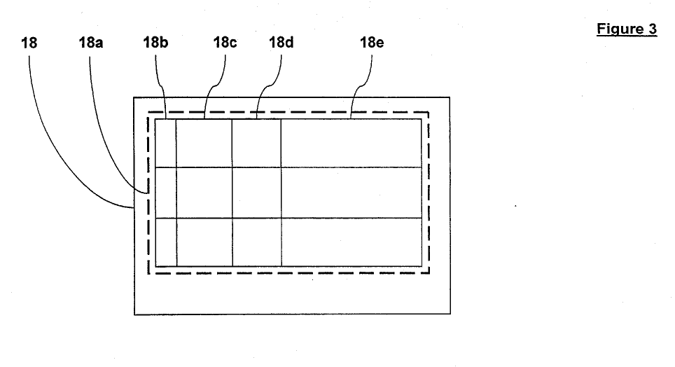

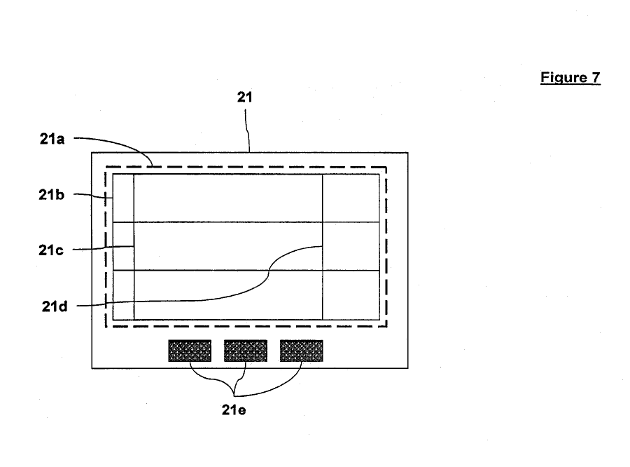

Now by referring to FIGS. 3, 4, 5, 6 and 7, a description will follow on the variations in design of elements posted on a screen 16 of a computer device 17 using distribution devices 28.

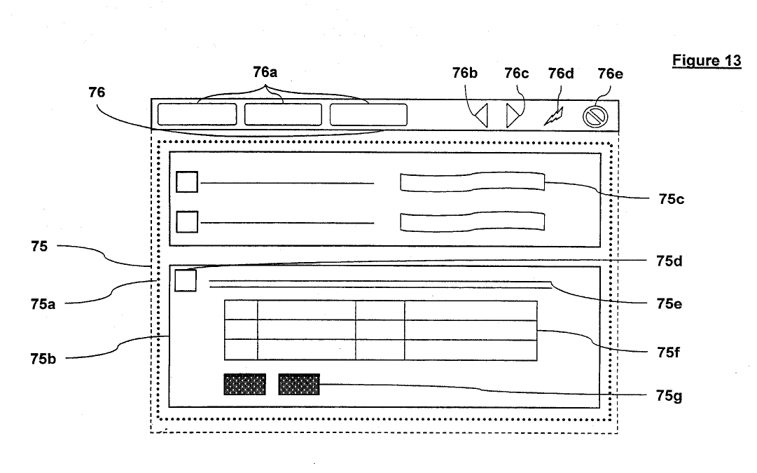

Under FIG. 13 a first classification of consumer needs 18 has been represented and calculated from a fourth calculation device. This first classification of consumer needs 1 is presented under the form of a column 18a containing in particular ranking of needs 18b and/or a column of comments on needs 18d and/or a column of comments 18e on the needs.

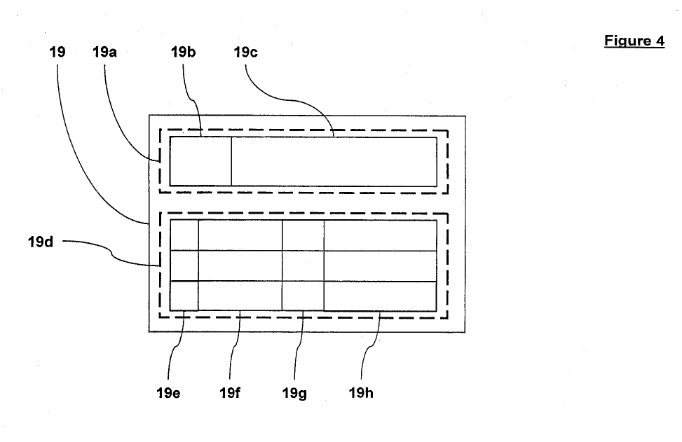

Under FIG. 4 is presented, for each need belonging to one of the first classification of needs 18, statement 19 of this need. The state of a need 19 is presented under the form of a column 19a that includes in particular a column of images 19b and/or a column of synthesized comments on the state of need indicators 19c. The state of need 19 is presented also in the form of a column of indicators 19d that includes a column of icons of indicators and/or a column of title indicators 19f and/or a column of values of indicators 19g and/or a column of comments on indicators 19h.

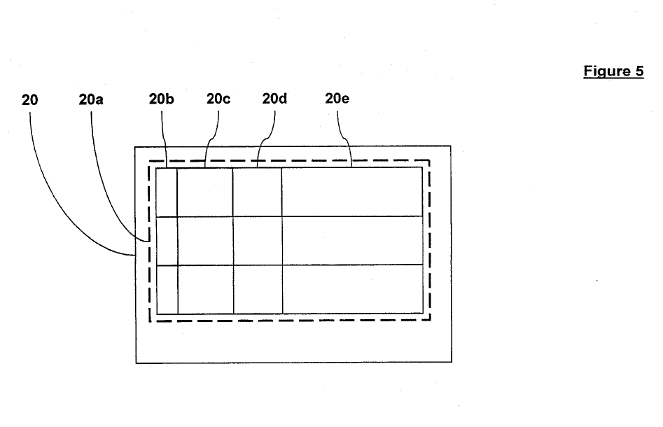

Under FIG. 5 there has been presented, for each need belonging to one of the classification needs 18, a second classification 20 of products and services of operator 5 meeting the needs of consumer 1. This second classification of products and services 20a includes a column of ranking of products and services 20b and/or a column of images of products and services 20c and/or a column of comments on products and services 20e.

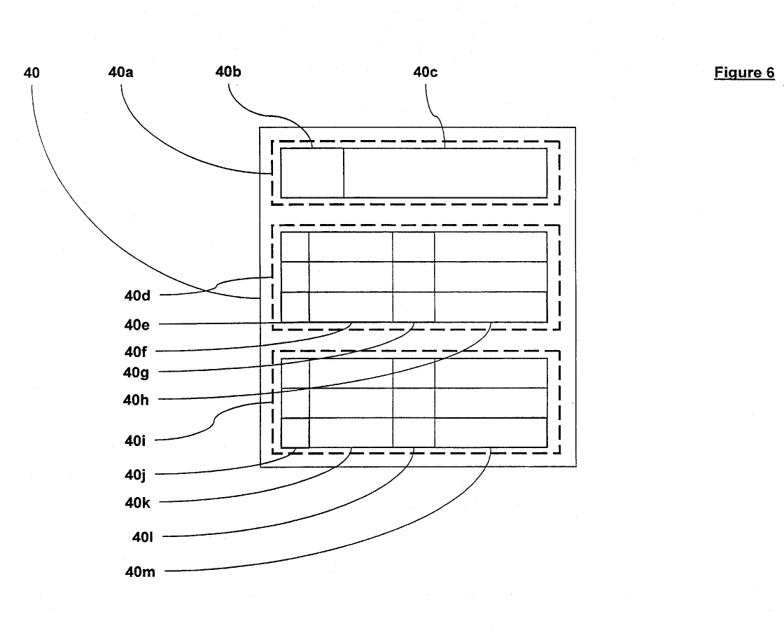

Under FIG. 6 there has been presented, for each product and service belonging to the second classification 20, a statement on products and services 40 of operators 5. This statement 40 includes a column of products and services 40a that includes a column of images of products and services 40b and/or a column of synthesised comments on products and services 40c. This statement 40 is also presented under the form of a table indicating advantages and disadvantages of the products or services 40d that includes a column of images symbolising the advantages or disadvantages 40e and/or a column of titles on advantages and disadvantages 40f and/or a column of values of advantages and disadvantages 40g and/or a column of synthesised comments on advantages and disadvantages 40h. This statement 40 is also presented under the form of a table of characteristics of the product and services 40i that includes a column of images of characteristics of the product and services 40j and/or a column with titles of characteristics of the product and service 40k and/or a column of values of the characteristics of the product and services 401 and/or a column of synthesised comments on the product and services 40m.

Under FIG. 5 there has been presented, for each product and service belonging to the second classification 20, a state of actions method 21 enabling consumers 1 to purchase products and services from operators 5. This state of action method 21a includes a column of possible actions 21b and/or a column of comments on possible actions 21c and/or a column of values on possible actions 21d and/or buttons 21e activating the actions related to the action process 21, in particular printing a report or mailing requesting a meeting.

According to the invention, the system and the method enable the consumer to navigate the computer software in an ergonomic manner by adapting to the profession of the consumer.

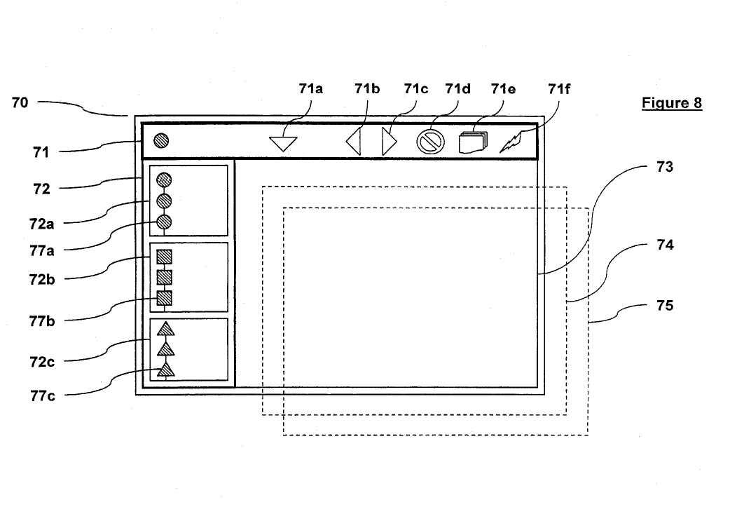

A. Software module 8 includes in particular a first window of navigation 70, represented in FIG. 8. This first window of navigation 70 contains in particular the following component parts:
First general navigation bar 71.
Explorer 72.
Second window of navigation 73.

The first navigation bar 71 contains, in particular, the buttons enabling to navigate the general navigation window 70, and more specifically to select 71a one of the second navigation windows 73 among those that are open, return 71b to the previous second window of navigation 73, advance 71c to the following second window of navigation 73, close the window of navigation 73 en route 71d, post 71e explorer 72, and personalise 71f of said software module 8.
A first environment explorer 72a structure in the form of a tree that contains consumer environment 77a adapted to the activity of the consumer 1, in particular a professional and a personal environment.
A second explorer of objects 72b appropriate to the activity of the consumer 1, in particular for the professional environment, the appropriate objects are namely: client supplier, bank, and employee.

A third explorer of actions 72c structured in the form of a tree that contains actions 77c attached to objects, in particular for the object client, those of creating an invoice, see overdue payment clients, and create a sales forecast.

The second window of navigation 73 contains in particular, and/or:
The representations of environment 74.
Action assistants 75.

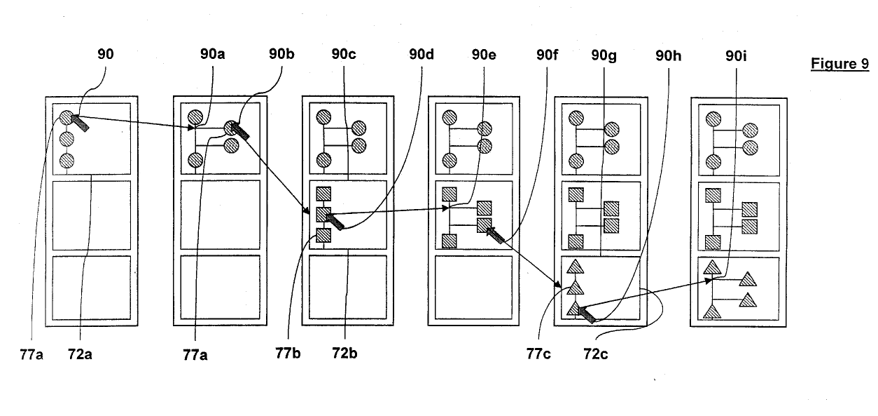

B. Under FIG. 9 the first level of operation of explorer 72 has been presented.

The consumer 1,
By clicking 90 through the computer device command on a knot on the tree contained in the first environment explorer 72a scrolls first 90a of the affiliate environment 77a.
By effecting a second click 90b via the computer device command on one of the environment affiliates 77a, posts a first 90c in the second explorer of objects 72b, the tree of objects 77b.
By effecting a third click 90d using the computer device command on objects 77b; scrolls affiliate objects 77b in a section 90e.
By effecting a fourth click 90f using the computer device command on an affiliate object 77b, posts a second 90g on the third explorer of actions 72c, the tree of actions 77c.
By effecting a fifth click 90h using the computer device command on one of the actions 77c proceeds to actions 77c in a third 90i.

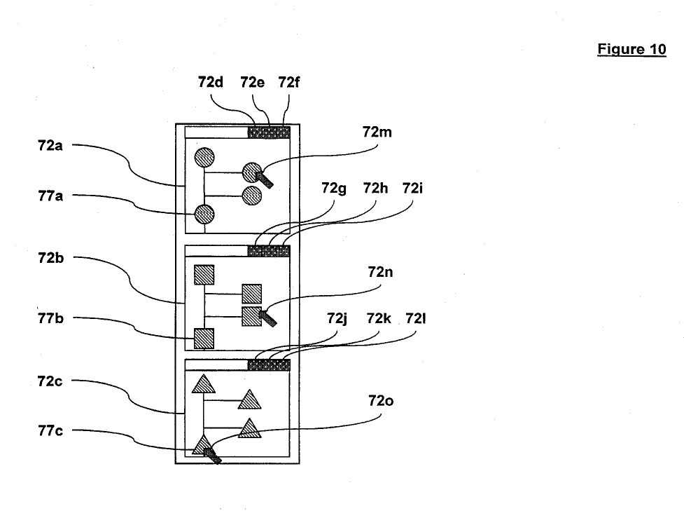

C. The second level of operation of explorer 72 has been represented in FIG. 10.

The first environment explorer 72a contains in particular functions enabling the consumer 1 to adapt environments 77a, in particular:
By creating a new environment 77a in a first 72d, and/or
By deleting firstly from 72e one of the environments 77a and/or modifying firstly the properties of environment 77a from 72f after selecting one of the environments 77a with a sixth click through the computer device command.

The second explorer of objects 72b contains in particular functions that enable consumer 1 to adapt objects 77b, namely:
By creating a new object 77b in a second 72g and/or
By deleting one of the objects 77b in a second 72h and/or modifying the properties of one of the objects 77b in a second 72i after selecting one of the objects 77b with a seventh click via the computer device command.

The third explorer of actions 72c contains in particular functions enabling the consumer 1 to adapt actions 77c, namely:
By creating a new action 77c in a third 72j and/or
By deleting one of the actions 77c in 72k and/or modifying the properties of one of the actions 77c in a third 72l after selecting one of the actions 77c with an eight click 720 on the computer device command.

It is understood by environment property 77a and/or objects 77b and/or actions 77c that these refer in particular to a label, image, icon, identifier, or command to execute. For example, the action 77c <<Create an invoice>> possesses the following properties: label=<<Create an invoice>>; image=<<Invoice image. Jpg>>; icon=<<Invoice icon. If>>, identifier=[234567>>, command to execute=<<Code line>>.

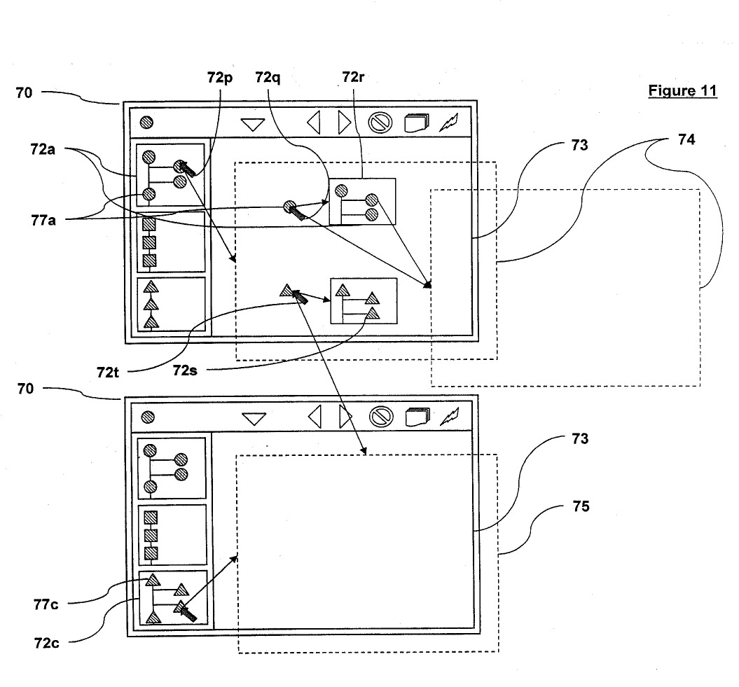

D. FIG. 11 presented the functions of the second window of navigation 73.

The posting of an environment presentation 74 is effected by selecting one of the 77a environments in the first explorer 72a by a ninth click 72p via the computer device command and/or selecting one of the environments 77a in one of the environment presentations 74 with a tenth click on the computer device command.

The posting of one of the action assistants 75 is affected by selecting one of the actions 72c in the third explorer of actions 77c and/or selecting one of the 77c actions in one of the environment 74 presentations.

A first posting 72r of the first environment explorer 77a is effected by selecting one of the environment presentations 74 by a tenth click 72q on the computer device command.

A second posting 72s of the third explorer of actions 72c is affected by selecting one of the actions 77c in 72t in one of the environment presentations.

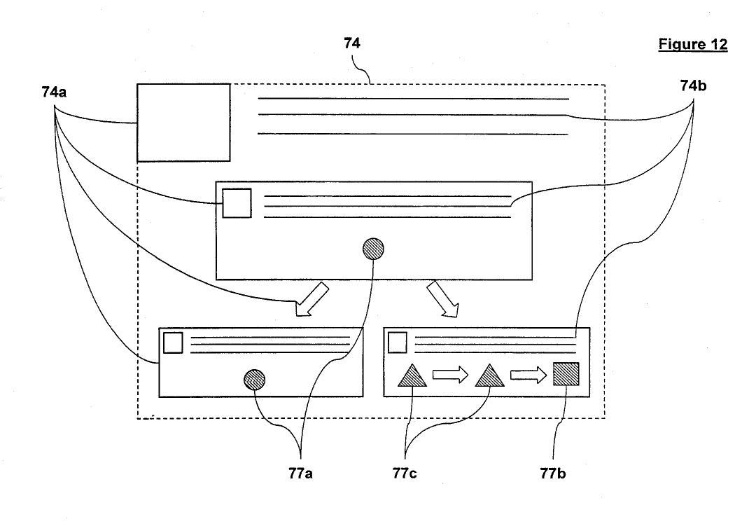

E. In FIG. 12 the functions of environment 74 presentations has been represented.

The presentation of environment 74 contains different elements, in particular, environments 77a and/or objects 77b and/or actions 77c and/or images 74a and/or text zones 74b.

The consumer can create and/or delete and/or modify and/or move elements of presentation 74 onto the screen in such a manner than the environment 74 presentations can be personalised as a function of the thinking logic and/or manner in which the consumer 1 organises their activities. The elements contained in the environment 74 presentation are stored in the memory.

The environment 74 presentations enable in particular consumer 1 to organise access to files contained on the hard drive in a personalised manner. For example, consumer 1 that administrates in particular the commercial aspect of a firm, traditionally creates numerous files, in particular of the text or spreadsheet type using market software. These files are traditionally accessed from a file explorer supplied by the operating system and classified in directories. From software module 8, the consumer 1 can create an environment 74 presentation whose title is <<My commercial work>> in order to place a shortcut to their files and/or directories adding explanatory notes and/or images. The placing of shortcuts to files and/or directories is effected thanks to a simple movement of the mouse to files and/or directory contained in the file explorer to the environment 74 presentation. According to the invention, the system and method enable the consumer 1 to dispose of a comprehensive and personalised view of their files and/or directories as opposed to the traditional view obtained by standard market file explorers.

F. FIG. 13 has presented the functions of action assistant 75.

The action assistant 75 contains in particular the following component parts:
A second navigation bar 76.
Stages 75a.
Blocks 75b contain each of the stages 75a referred to.
The elements contained in each of the mentioned 75b blocks, principally capture and/or visualisation fields 75c, images 75d, text zones 75e, capture and/or visualisation fields 75f, and buttons 75g activating these functions.

The captured and/or visualised data in action assistant 75 are stored in memory.

The second navigation bar 76 contains in particular text zones showing title 76a of stages 75a, buttons enabling to navigate action assistant 75 and in particular, to go to stage 75a before 76b, go to said stage 75a following 76c, adapt the action assistant 76d, and close 76e action assistant 75.

Software module 8 contains in particular functions enabling the consumer 1 to adapt action assistants 75 as a function of the needs of consumer 1.

The consumer 1 can create and/or delete and/or move stages 75a and/or blocks 75b and/or elements contained in blocks 75b.

The capacity of adaptability of the system is made possible in particular thanks to:
The structure of software module 8 in environment 77a, objects 77b and actions 77c.
The personalisation of environment presentations 74.
The personalisation of action assistants 75.

The adaptation of the system is effected manually by the consumer 1 and/or automatically.

Manual Adaptation Method:

Consumer 1 can manually personalise the system by personalising the elements contained in explorer 72 (Refer to FIG. 10) and/or by personalising the environment 74 presentations (Refer to FIG. 12) and/or action assistants 75.

Automatic Adaptation Method:

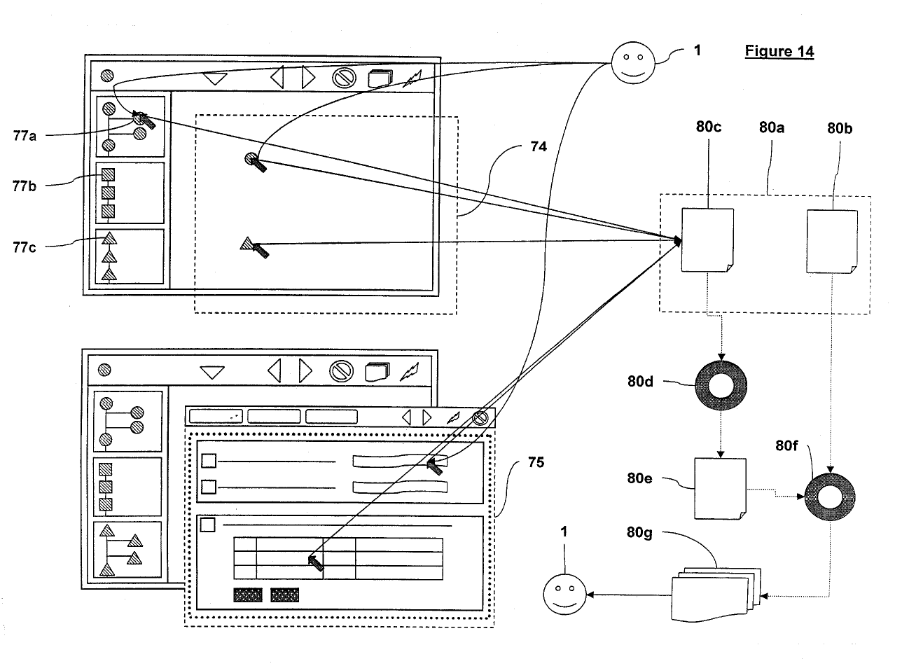

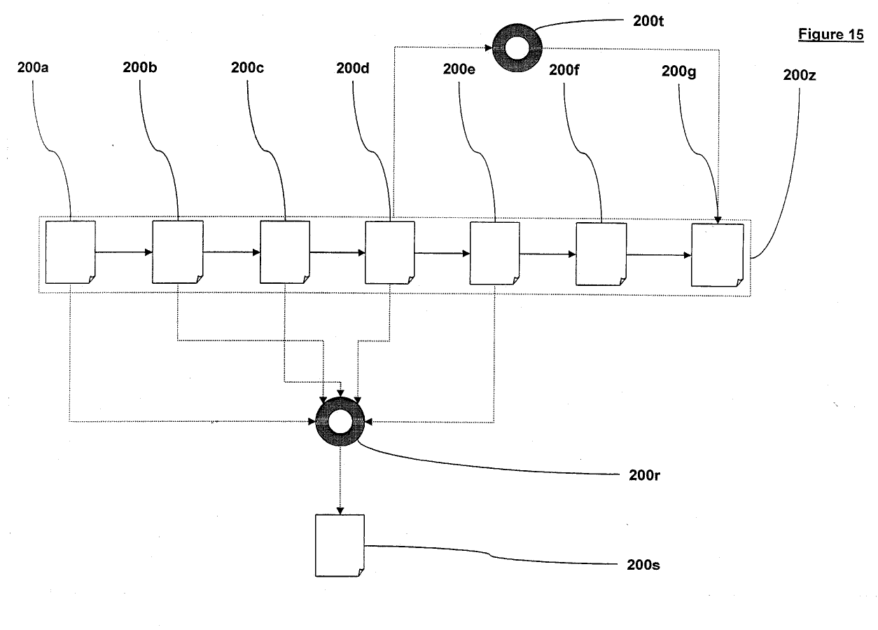

FIG. 14 has represented the automatic adaptation method.

The system is capable, as a function of the use of software module 8 made by consumer 1, to adapt automatically. The automatic adaptation covers in particular the structure of environment 77a and/or objects 77b and/or actions 77c, on environment 74 presentations, action assistants 75.

On the one part, the system stores in memory 80a the models of use 80b appropriate to consumer 1 activities, in particular personal and professional activities (Restaurant, building, commercial, accounting).

On the other part, the system stores in memory 80a the history of actions 80c of consumer 1 carried out by software module 8.

Then, from the history of actions 80c, a fourth set of calculation methods 80d determines:
The indicators of use 80e of environment structure 77a, objects 77b and actions 77c, in particular the rate of clicking on environments 77a, objects 77b and actions 77c, the sequence of clicks between environments 77a, objects 77b and actions 77c, and the frequency of clicks on environments 77a, objects 77b and actions 77c.
The indicators of use of environment presentations, in particular the clicking on elements contained in environment presentation 74, the sequence of clicks between these elements, the frequency of clicks on these elements, the time during which said presentation is open, and the rate and frequency of opening of environment presentation 74.
The indicators of use 80e of action assistants 75, in particular the rate of clicks on elements contained in blocks 75b.

The system has available a fifth method of calculation 80f which uses, on one part usage indicators 80e and on the other part models of use 80b proposed to said consumer 1:
An automatic modification 80g on the structure of environment 7a, objects 77b and actions 77c into a structure that is more adapted to the manner in which the consumer 1 uses the system.
An automatic modification to environment presentations 74, in particular deleting and/or adding and/or modifying the elements contained in environment 74 presentations and a reorganisation of the location of these elements in the environment presentation 74.
An automatic modification 80g of action assistants 75, in particular to create and/or delete and/or modify and/or move stages 75a and/or move blocks 75b and/or the elements contained in said 75b blocks.

Consumer 1 visualises the automatic modifications 80g proposed and can validate and/or reject whether these automatic modifications affect the system.

Now a description will follow, more specifically how the system is capable of, as a function of the use of software module 8 by the consumer, on how to detect their needs. The same technical devices comparable to those that have been described hereunder are activated. They carry the same numerical references sending the same elements represented.

Software component 4 activates a software module 8 structured as follows:
Consumer environment 9 adapted to the activities of the consumer, in particular the professional and personal environments.
Objects 10 appropriate to consumer 1, in particular for the objects client, supplier, bank, employee.
Actions 11 that are attached to objects 10, in particular for the object client, the actions of creating an invoice, see overdue payment clients, and create a sales forecast.

Upon launching the software program, the user selects, among a series of available environments, those that correspond to their needs. The user has available in this manner a personalised navigation space responding to their needs. The other environments that are of no interest do not appear in their navigation space.

As a function of the use of software module 8 by the consumer 1, the system is capable of detecting their needs.

The detection of needs arises in particular from the use of the structure of environment 77a and/or objects 77b and/or actions 77c and/or presentations of environment 74 and/or action assistants 75.

On the one part, the system stores, in memory 80a, the models of use 80b belonging to different types of activities of consumer 1, in particular personal and professional activities (Restaurant, building, commercial, accounting).

On the other part, the system stores, in memory 80a, the history of actions 80c of consumer 1 administered by software module 8.

Then, from the history of actions 80c, a first method of calculation 80d determines:
Usage indicators 80e of the environment structure 77a, objects 77b and actions 77c, in particular the rate of clicks between environment 77a, objects 77b and actions 77c, the sequence of clicks between the environments 77a, objects 77b and actions 77c, and the frequency of clicks on environments 77a, objects 77b and actions 77c.
The usage indicators 80e of environment presentations 74, in particular the click on elements contained in environment presentations 74, the sequence of clicks between these elements, the time during which environment presentations 74 is open, the rate and the frequency of opening of environment presentations 74.
The usage indicators 80e of action assistants 75, in particular the rate of clicks on elements contained in blocks 75b.

The system disposes of a method of calculation which detects the needs of the consumer from usage indicators 80e. At regular frequency the software updates itself automatically via internet in the following manner: The user receives environment updates that correspond to their needs. For example, if the method of calculation has enabled to detect a usage of the environment <<My Jazz Music>>, this environment is updated.

The user accesses the detection of their needs from their different environments. For example, in the environment My Music, the user visualises the new jazz records released this month.

According to the invention, the system and method enable the consumer to manage their personal and/or professional finances with a unique click 201. To this effect:

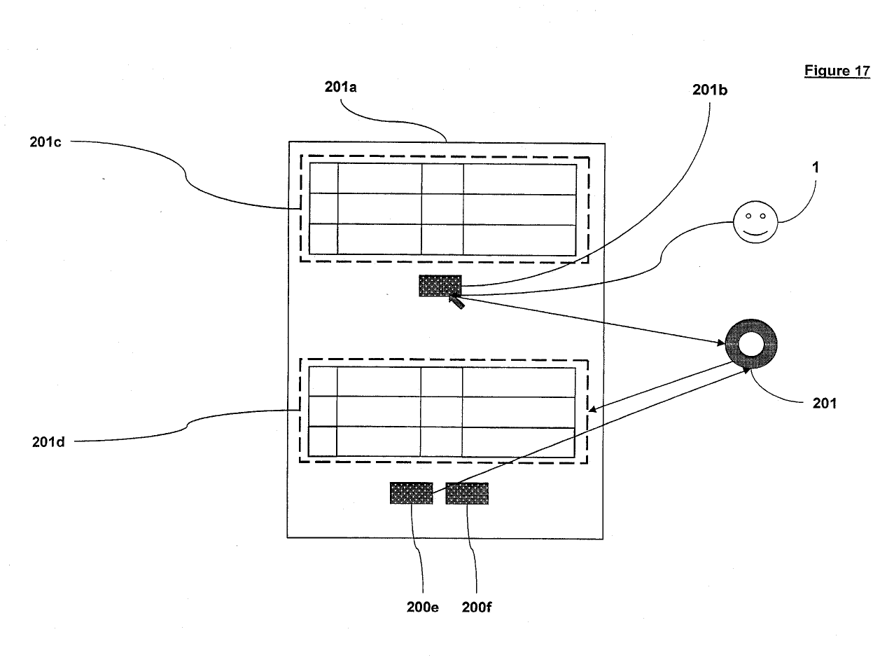

A. Software module 8 includes in particular a unique click window 201a that integrates the unique function 201, represented by FIG. 17. The unique click window 201a contains in particular the following component parts:
A first table of bank reports 201c of said consumer 1.
A unique click button 201b activating the unique click function 201.
A second table of solutions 201d generated by the unique click function 201.
A button, find another solution 200e, that enables to launch the unique click function 201 for the line selected by consumer 1 in the table of bank statements 201c, in the case where the first solution found by unique click function 201 does not suit consumer 1.

A button, consult details of solution 201f, that enables to visualise details of the line selected by the consumer 1 in the table of solutions 210d.

B. FIG. 5 has represented one of the functions of traditional management of software module 8.

Traditionally software module 8 enables in particular consumer 1 to carry out the series of stages 200z, i.e.: capture forecasts 200a regarding their activity, create estimates and/or commands and/or invoices 200b, create payment due dates 200c, register payments 200d, register payment orders 200e to banks, recover bank statements 200f and consult statements, in particular past and future cash flow statements 200g.

Traditionally, software module 8 includes, in particular, a seventh method of calculation 200r enabling to create estimates and/or commands and/or invoices 200b for each stage, create payment due dates 200c, register payment orders 200e, automatically and invisible to the consumer 1 generate bank statements 200s. For example, the capture by consumer 1 of an invoice in the stage of creating invoices 200b automatically generates the following bank statements 200s:

| | | | | |
|---|---|---|---|---|
| VE | 411DUPONT | Client | 73.4 | Debit |
| VE | 70600000 | Sale | 56.4 | Credit |
| VE | 44571000 | VAT 19.60 | 11.06 | Credit |

Traditionally, the software module 8 includes in particular an eighth method of calculation 200t enabling, from corresponding statements of said series of stages 200z, to update the forecast statements 200a.

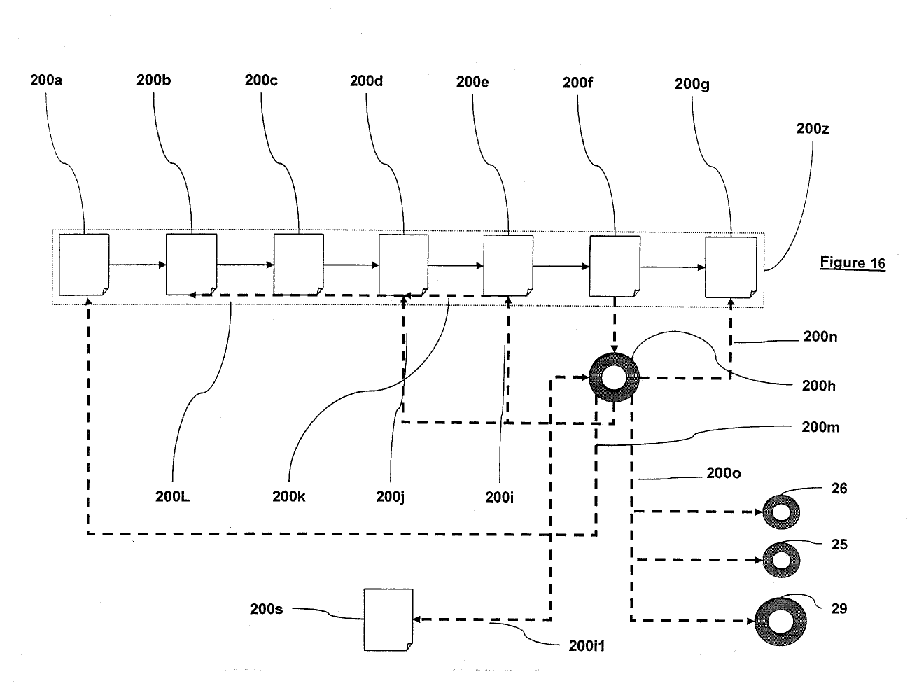

C. FIG. 16 has represented the functioning of unique click function 201.

Unique click function 201 enables the consumer 1 to automatically effect, in one single click, with almost no manual capture, the entire and/or part of the series of stages 200z.

The unique click function 201 includes a sixth method of calculation 200h that automatically enables, in particular, to:
Recover bank statements 200f by downloading and/or
Attach the bank statements 200i of said 200f statements with accounting statements 200s and/or
Create firstly 200i from bank statement reports 200f that have not been attached to bank statements 200s, the reports corresponding to stages: Register payment orders 200e when payment is effected by cheque and/or cash and/or
Create secondly a 200j from bank statement reports 200f that have not been attached to bank statements 200s, the reports corresponding to stages: Register payments 200d when the method of payment is in particular transfers and/or cash withdrawals with bank card and/or
Create thirdly 200k from the preceding action create firstly 200i, bank statement reports corresponding to stages: Register payments 200d and/or
Create a fourth 200L from the preceding action create 200k and/or from the preceding action create 200j, reports corresponding to stages: Create estimates and/or command sand/or invoices 200b and/or create payment due dates 200c and/or
Fifthly, create and/or modify reports corresponding to the stage capture forecasts 200a in such a manner that the reports generated automatically regarding forecasts, in particular sales and/or expenses and/or taxes and/or investments and/or purchases and calculated from reports corresponding to series of stages 200z and/or
Firstly calculate 200n in particular cash flow statements both past and future from reports corresponding to series of stages 200z.
Firstly execute 200o the third method of calculation 26 and said methods of calculation 25.

1. The method relates to an automatic method of anticipating, identifying, analyzing and meeting the needs of consumers (1) in real time, where said aforementioned consumers (1) activate data processing methods (2) in particular management modules and/or navigation modules and supply said methods of data processing (2), with personal data (3) related to their activities, with the method including:
The stage of associating a computer software program (4) to said data processing methods (2) enabling to reveal the consumer (1) needs from said personal data (3), Said computer software program (4) activates a software module (8) structured as follows:
Consumer environments (9) adapted to the activity of said consumer (1), in particular a personal and a professional environment, Objects (10) appropriate to the activity of said consumer (1), in particular for the professional environment, the objects client, supplier, bank and employee, actions that are attached (11) to said appropriate objects (10), in particular for the object client, the actions create an invoice, see overdue payment clients, and create a sales forecast, said method also includes the stage of distributing to consumers (1) said data processing software component (4).

2. Method according to claim 1 in which: Said methods of data processing (2) have been designed in particular to provide statements on past and/or present situations, in particular accounting statements from said method, data (3) related to the activities of said consumers (1), said method being such that in order to reveal the needs of consumers (1) said software component (4): calculates forecast statements (7) from (i) of said personal data (3) related to the activities of said consumers (1) and/or complementary data (6) provided by said consumers (1) and related to their activities and calculates the consumer needs (1) from (i) said personal data (3) and/or (ii) from said complementary data (6) (iii) and/or forecast statements (7).

3. Method according to any of claim 1 where said software module (8) includes also the following stages: a stage of generating automatically the statements and/or documents, in particular during the activation of said attached actions (11), a stage of automatically calculating said forecast statements (7) upon each update by said consumer (1) and/or said complementary data (6) related to their activities, a stage of storing in memory (12), on the one part, said personal data (3) and/or said complementary data (6) and/or said forecast statements (7), on the other part, descriptions (13) of products and/or services offered by operators (5), said software module (8) includes also an automatic calculation of the consumer (1) need s, the stage to calculate from stored data in said memory (12) with indicators 14) regarding the activity of the consumer, wit degrees of relevance (15) of products and/or services offered by operators (5) and said software module (8) includes also the stage to propose to said consumer (1) said products and/or said services corresponding to the needs thus calculated.

4. Method according to any of claim 2 where said software module (8) includes also the following stages: a stage of generating automatically the statements and/or documents, in particular during the activation of said attached actions (11), a stage of automatically calculating said forecast statements (7) upon each update by said consumer (1) and/or said complementary data (6) related to their activities, a stage of storing in memory (12), on the one part, said personal data (3) and/or said complementary data (6) and/or said forecast statements (7), on the other part, descriptions (13) of products and/or services offered by operators (5), said software module (8) includes also an automatic calculation of the consumer (1) need s, the stage to calculate from stored data in said memory (12) with indicators 14) regarding the activity of the consumer, wit degrees of relevance (15) of products and/or services offered by operators (5) and said software module (8) includes also the stage to propose to said consumer (1) said products and/or said services corresponding to the needs thus calculated.

5. A Method according to any of the claims 2 in which said software module (8) includes also a stage to post on the screen (16) a data processing device (17): A first classification of needs (18) of said consumers (1) as a function of said degrees of relevance (15), and/or a statement of needs (19) of said consumers (1) and said indicators (14), and/or a second classification (20) and/or a statement of said products and services of said operators (5) responding to needs of said consumer (1) in particular by presenting the advantages and disadvantages of said products and services so classified (20 or appearing on said statement, and/or methods of action (21) enabling said consumers (1) to purchase said products and services so classified or appearing on said statement.

6. A Method according to any of the claims 3 in which said software module (8) includes also a stage to post on the screen (16) a data processing device (17): A first classification of needs (18) of said consumers (1) as a function of said degrees of relevance (15), and/or a statement of needs (19) of said consumers (1) and said indicators (14), and/or a second classification (20) and/or a statement of said products and services of said operators (5) responding to needs of said consumer (1) in particular by presenting the advantages and disadvantages of said products and services so classified (20 or appearing on said statement, and/or methods of action (21) enabling said consumers (1) to purchase said products and services so classified or appearing on said statement.

7. The system relates to an automatic method of anticipating, identifying, analyzing and meeting the needs of consumers (1) in real time. Said consumers (1) activate computer devices (22) that include data processing methods (2) in particular management and/or navigation software models and provide said data processing devices (2) with personal data (3) related to their activities, said system includes a data processing software component (4) associated to said data processing methods (2), enabling to reveal the consumer needs (1) from said data, said software component (4) activates a software module (4) activating a software module (8) structured as follows: Consumer environments (9) adapted to the activity of said consumer (1) in particular the professional and personal environments, objects (10) appropriate to the activities of said consumer (1) in particular for the professional environment, the objects client, supplier, and see overdue payment clients an employee, actions that are attached (111) to appropriate objects (10) in particular for the object client the actions create an invoice, see overdue payment clients, and create a sales forecast with said data processing software component (4) being distributed to said consumers (1).

8. System according to claim 7 in which said data processing methods been more particularly designed to provide statements on past and/or present situations, in particular accounting statements, from personal data (3) related to the activities of said consumers (1), said software component 4) includes calculation methods (23) enabling to reveal consumer needs (1): by calculating the forecast statements (7) from (i) of said personal data (3) related to the activities of said consumers (1) and/or (ii) complementary data (6) provide by said consumers (1) related to their activities, by calculating the needs of consumers (1) from (i) of said personal data (3) and/or said complementary data (6) (iii) and/or forecast statements (7).

9. System according to any of the claim 7 in which said software module (8) includes also the first methods of calculation (24) enabling to automatically generate statements and/or documents, in particular during updating of said attached actions (11), to automatically calculate said forecast statements (7) upon each update by said consumer (1) of said personal data (3) and/or said complementary data (6) related to their activities with said data processing software includes also a memory (12) enabling to store on the one part, said personal data (3) and/or said complementary data (6) and/or said forecast statements (7) and on the other part, descriptions (13) of products and services offered by operagoer (5), said software module 8) includes also a second method of calculation (25) enabling to effect calculations from data stored in said memory (12), indicators 14) on the activity of the consumer, degrees of relevance 15) of products and services offered by said operators (5), said software module (8) includes also a third method of calculation (26) to calculate the consumer needs (1) from said indicators (14) and degrees of relevance (15), said software module (8) includes also methods of distribution (27) to offer said consumers (1) said products and/or services corresponding to the needs thus calculated.

10. System according to any of the claim 8 in which said software module (8) includes also the first methods of calculation (24) enabling to automatically generate statements and/or documents, in particular during updating of said attached actions (11), to automatically calculate said forecast statements (7) upon each update by said consumer (1) of said personal data (3) and/or said complementary data (6) related to their activities with said data processing software includes also a memory (12) enabling to store on the one part, said personal data (3) and/or said complementary data (6) and/or said forecast statements (7) and on the other part, descriptions (13) of products and services offered by operagoer (5), said software module 8) includes also a second method of calculation (25) enabling to effect calculations from data stored in said memory (12), indicators 14) on the activity of the consumer, degrees of relevance 15) of products and services offered by said operators (5), said software module (8) includes also a third method of calculation (26) to calculate the consumer needs (1) from said indicators (14) and degrees of relevance (15), said software module (8) includes also methods of distribution (27) to offer said consumers (1) said products and/or services corresponding to the needs thus calculated.

11. System according to any of claims 9 in which said software module (8) includes also a posting method (28) to post a computer device (17) on ht screen (16): a first classification of needs (18) of said consumers (1) as a function of said degrees of relevance (15), and/or a statement of needs (19) of said consumers (1) and said indicators (14), and/or a second classification (20) and/or a state of said products and services of said operators (5) responding to said consumer needs (1), in particular by presenting the advantages and disadvantages of said products and services so classified by said state of needs (19), and/or methods of action (21) enabling said consumers (1) to purchase said products and services so classified or appearing on said statement.

12. System according to any of claims 10 in which said software module (8) includes also a posting method (28) to post a computer device (17) on ht screen (16): a first classification of needs (18) of said consumers (1) as a function of said degrees of relevance (15), and/or a statement of needs (19) of said consumers (1) and said indicators (14), and/or a second classification (20) and/or a state of said products and services of said operators (5) responding to said consumer needs (1), in particular by presenting the advantages and disadvantages of said products and services so classified by said state of need s (19), and/or methods of action (21) enabling said consumers (1) to purchase said products and services so classified or appearing on said statement.
